(19) United States
(12) Patent Application Publication
(10) Pub. No.: US 2022/0084424 A1
(43) Pub. Date: Mar. 17, 2022

(54) INTERACTIVE COMMUNICATION SYSTEM FOR SPECIAL NEEDS INDIVIDUALS

(71) Applicants: Daniel Gray, Winter Garden, FL (US); Alejandro Echeverry, Orlando, FL (US)

(72) Inventors: Daniel Gray, Winter Garden, FL (US); Alejandro Echeverry, Orlando, FL (US)

(21) Appl. No.: 17/475,945

(22) Filed: Sep. 15, 2021

Related U.S. Application Data
(60) Provisional application No. 63/079,055, filed on Sep. 16, 2020.

(51) Int. Cl. G09B 5/06; G06F 3/0484; H04L 29/08; G06F 3/16; G09B 19/04

(52) U.S. Cl. CPC G09B 5/06; G06F 3/0484; G06F 3/0488; G06F 3/167; G09B 19/04; H04L 67/26

(57) ABSTRACT

An interactive communication system includes a primary interface device, at least one location-specific interface device, and at least one caregiver interface device. Each of the interface devices include functionality for sending and receiving secure communications across a wireless network. The primary interface device includes a data bank library that contains user-specific locations, each having a specific set of verbs and corresponding nouns. At least one of the locations is assigned a location-specific interface device. The primary interface device also includes a library of caregivers, and at least one of the caregivers is assigned one of the caregiver interface devices. The primary interface device includes functionality for formulating a request containing a selected caregiver name, location-specific verb, and location specific noun. The formulated request is broadcast by the primary interface device speaker and pushed to the associated caregiver interface device and location-specific interface device.

### CROSS-REFERENCE TO RELATED APPLICATIONS

This application claims the benefit of U.S. application Ser. No. 63/079,055 filed on Sep. 16, 2020, the contents of which are incorporated herein by reference.

### TECHNICAL FIELD

The present invention relates generally to an animated learning and communication system, and more particularly to a system having a plurality of communication devices for teaching, reinforcing, and communicating with special needs individuals.

### BACKGROUND

The statements in this section merely provide background information related to the present disclosure and may not constitute prior art.

Children and adults with special needs, such as autism, for example, have difficulty communicating verbally. As a result, it is not uncommon for such individuals to become highly stressed or agitated when trying to verbally convey information to a caregiver or other individual. Even simple requests such as asking for a drink can be quite stressful, as the individual may not be able to convey exactly what they want or need.

Although certain non-verbal individuals can utilize computers or tablets to type what they cannot say, such devices are not useful for individuals with physical dexterity limitations, learning disabilities, or other ailments commonly associated with autism. Indeed, caregivers for these individuals must often guess what the individual is actually trying to convey, which (if guessed incorrectly) can cause frustration to the individual and caregiver alike. Moreover, because these known devices are designed to replace spoken words, they have a tendency to reinforce non-verbal behavior by the individual, thereby making the and to nothing to reinforce and teach speaking habits.

Accordingly, it would be beneficial to provide an interactive communication system that includes a plurality of custom built devices each having a customizable menu of interactive visual aids to allow a special needs individual to convey a particular want, need or emotion to a caregiver. Additionally, it would be beneficial for the system to provide an audible feedback loop that verbally states the request conveyed by the individual, in order to help them match particular sounds and/or sentences with a desired action. In this regard, the inventive system functions to bridge the gap between a communication aid and occupational therapy.

### SUMMARY OF THE INVENTION

The present invention is directed to an interactive communication system for communicating with a special needs user.

One embodiment of the system can include a primary interface device, at least one location-specific interface device, and at least one caregiver interface device. Each of the interface devices can include functionality for sending and receiving secure communications across a wireless network.

In one embodiment, the primary interface device can include a data bank library that contains and can be uploaded with a plurality of user-specific information. The information can include locations where the primary user visits such as a kitchen, bedroom, bathroom, or school. In one embodiment, at least one of the locations can be assigned a location-specific interface device. Each location can have a plurality of location-specific verbs pertaining to actions the primary user may perform at the location. Each verb also has a plurality of location-specific nouns pertaining to items that would be associated with the selected verb.

In one embodiment, the primary interface device can include a library of core words representing common spoken words that can be continuously displayed on the screen of the primary interface device.

In one embodiment, the primary interface device can include a library of caregivers who represent people with whom the primary user communicates. In one embodiment, at least one of the caregivers can be assigned one of the caregiver interface devices.

In one embodiment, the primary user can select a caregiver from a list of caregivers on the display screen of the primary interface device. Upon selecting a caregiver, the primary user can select a location-specific verb and noun to form a request. The system can format the request in proper sentence format, audibly speak the generated request, and selectively push a notice containing the generated request to the caregiver's interface device and location-specific interface device associated with the generated request.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 shows an exemplary network environment of a system for performing interactive communication according to some embodiments of the technology.

FIG. 2 is an exemplary flow diagram illustrating a method for customizing the primary interface device, according to one embodiment.

FIGS. 3-9 each show exemplary interface presentation screens of the system, in accordance with one embodiment.

FIG. 10 is an exemplary flow diagram illustrating a method of communicating utilizing the system components, according to one embodiment.

FIGS. 11-15 each show additional exemplary interface presentation screens of the system, in accordance with one embodiment.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Identical reference numerals are used for like elements of the invention or elements of like function. For the sake of clarity, only those reference numerals are shown in the individual figures which are necessary for the description of the respective figure.

Although described for use by a management company for detecting and enforcing homeowner violations and the like, this is for illustrative purposes only. To this end, the inventive concepts may be readily adapted for use in any number of other industries without undue experimentation.

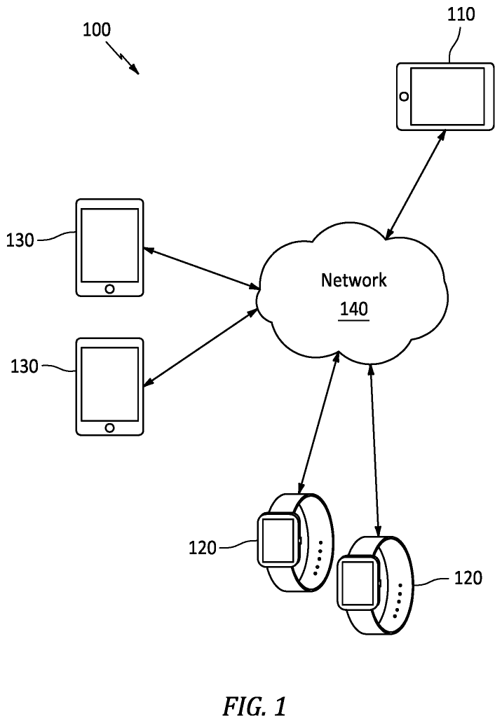

FIG. 1 illustrates one embodiment of an interactive communication system 100 for special needs individuals. In one embodiment, the system 100 can include a primary user interface device 110, at least one caregiver interface device 120, and any number of location-specific interface devices 130 that communicate directly over a closed and secure network 140.

As described herein, each of the interface devices 110, 120 and 130 can include processor-enabled devices such as a computer, tablet, or smart watch, for example, that can be operated by a human user. Moreover, each of the interface devices can also include one or more client applications, such as an application interface, for example, which can allow the device user to communicate with and view content from other devices over the network 140. Owing to the sensitive nature of the information to be shared across the system, each system component 110, 120 and 130 can preferably be constructed utilizing purpose-built interface devices having dedicated and password protected internal or external storage mediums. These purpose-built devices can further include network interface devices having an embedded security system such as a random number generator, for example, that can be synced across each system device to permit secure and direct communication between the device components. Such a feature can allow the purpose-built non-generic processor enabled devices 110, 120 and 130 to perform the below described methodology in a completely secure manner that cannot be achieved through the use of off-the-shelf hardware.

As described herein, the network 140 can include any type of transmission medium that facilitates any form of digital or analog communication (e.g., a communication network). Transmission mediums can include one or more packet-based networks and/or one or more circuit-based networks in any configuration. Packet-based networks can include, for example, the Internet, a carrier internet protocol (IP) network (e.g., local area network (LAN), and/or a wide area network (WAN). Circuit-based networks can include, for example, the public switched telephone network (PSTN), a wireless network (e.g., RAN, code-division multiple access (CDMA) network, time division multiple access (TDMA) network, global system for mobile communications (GSM) network), Bluetooth, WiFi, or Personal Area Networks (PANs), Near Frequency Communication (NFC) network, and/or other circuit-based networks.

Information transfer over the network 140 can be performed by a communication module based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), a Global System for Mobile Communications (GSM) protocol, a Push-to-Talk (PTT) protocol, a PTT over Cellular (POC) protocol, a Real-time Messaging protocol (RTMP), a Real-time Media Flow Protocol (RTMFP) and/or other communication protocols.

In the preferred embodiment, each of the devices can communicate utilizing a peer to peer (P2P) protocol over a wireless medium such as Wifi or Bluetooth, for example; however other protocols and connectivity mediums are also contemplated.

A method for communicating with a special needs individual utilizing the system 100 will now be described. The method can function to allow a special needs individual (aka the “primary user”) using the primary device 110 to access an onboard database of words to form sentences that convey his or her particular wants or needs at a given time. Once the want/need is formed, the primary unit can convey the information audibly to the primary user and can send the information electronically to the caregiver unit and one or more of the location-specific units.

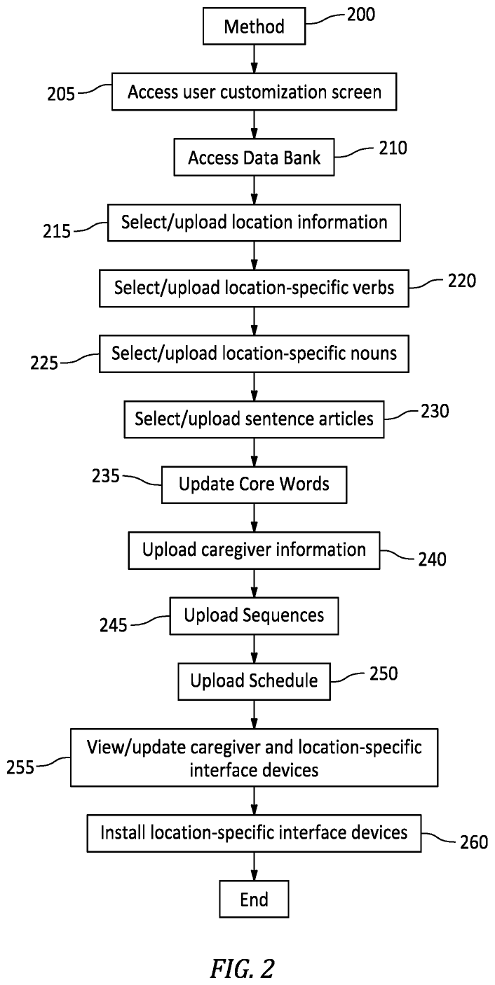

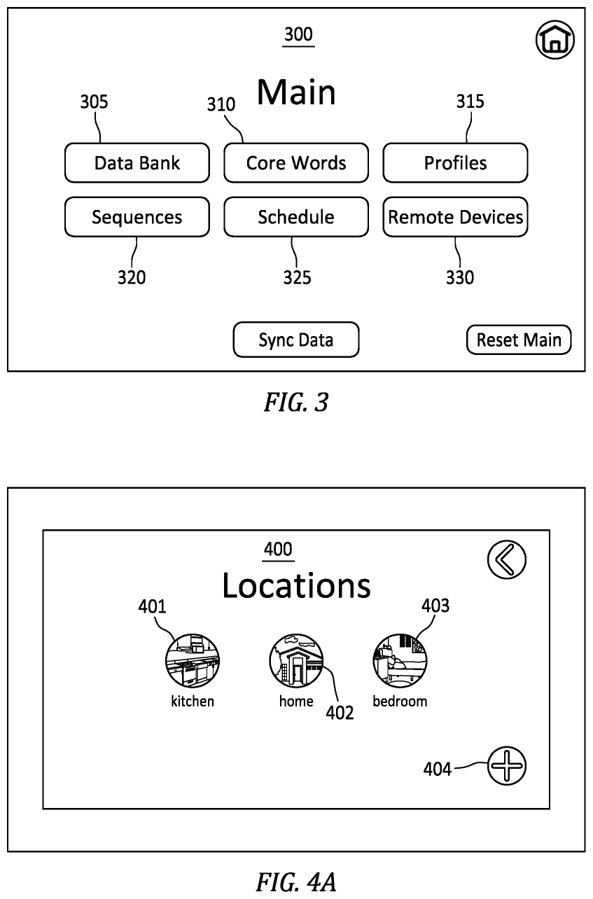

A method for performing interactive communication utilizing the system 100 will now be described with respect to FIG. 2. Moreover, several exemplary presentation screens which can be generated by the system are presented with respect to FIGS. 3-9 and 11-15. Although described below with respect to particular steps and screens, this is for illustrative purposes only, as the methodology described herein can be performed in a different order than shown, and the presentation screens can include any number of additional information and features. Although described below with regard to a user uploading information, embodiments of the invention contemplate some information such as commonly used core words, locations, verbs and/or nouns being pre-loaded into the system.

FIG. 2 illustrates an exemplary flow chart method 200 for customizing the primary interface device to facilitate interactive communication with a primary user. As will be described, the system is designed to utilize photographs, words, and animations to develop word/picture associations used in the development of sentence structures. The method steps described below will ideally be performed by the primary user's caregiver such as their parent, guardian, or therapist, for example; however, other individuals familiar with the primary user may also perform these steps.

As shown, the method 200 can begin at step 205 whereby the caregiver accesses the user customization screen of the primary interface device 110. In various embodiments, the user customization screen can be password protected utilizing a numeric sequence, password, or biometric identifier, as is known in the art.

In either instance, the user customization screen can include a plurality of individually selectable categories, each containing words, phrases, people, and/or locations that can be used by the primary user to form structured sentences to communicate with others using the system. Each category can be updated with additional content relevant to the primary user throughout the life of the system, allowing it to grow and expand as the users' vocabulary does the same.

FIG. 3 illustrates one nonlimiting embodiment of an exemplary user customization presentation screen 300, which can be generated by and displayed on the primary interface device 110. In the illustrated embodiment, the page 300 can include a “Data Bank” tab 305, a “Core Words” tab 310, a “Profiles” tab 315, a “Sequences” tab 320, a “Schedule” tab 325 and a “Remote Devices” tab 330. Each of the tabs can include a series of options housed in the onboard memory of the primary interface device 110.

The Data Bank tab 305 can comprise a library of locations, verbs and nouns that can be used by the primary user to convey a location specific request or action (See method 1000). The Data Bank library can be customized by the caregiver at step 210 whereby any number of words and photographs corresponding to location specific requests can be stored. In the illustrated embodiments, these requests can be broken into three categories 1) specific locations, 2) location specific verbs, and 3) location specific nouns.

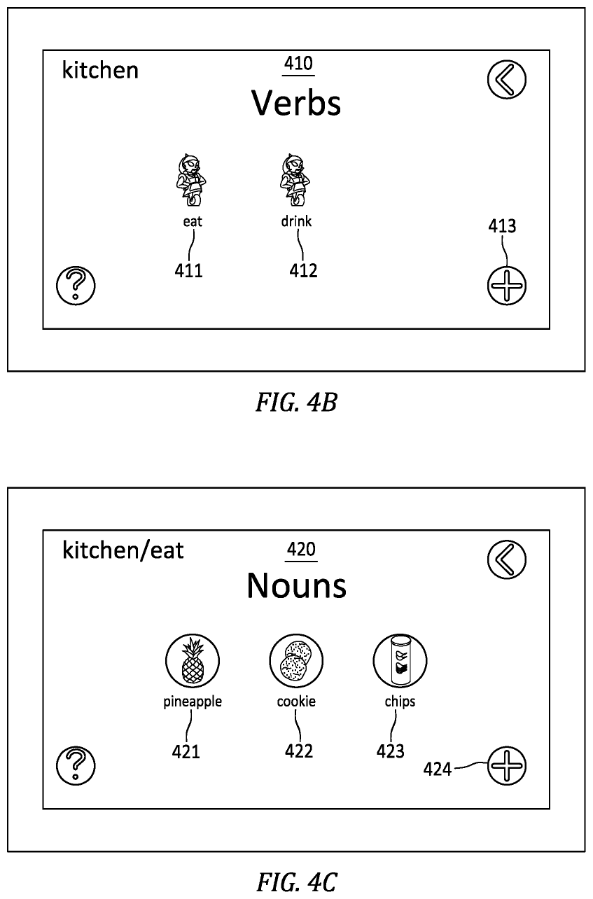

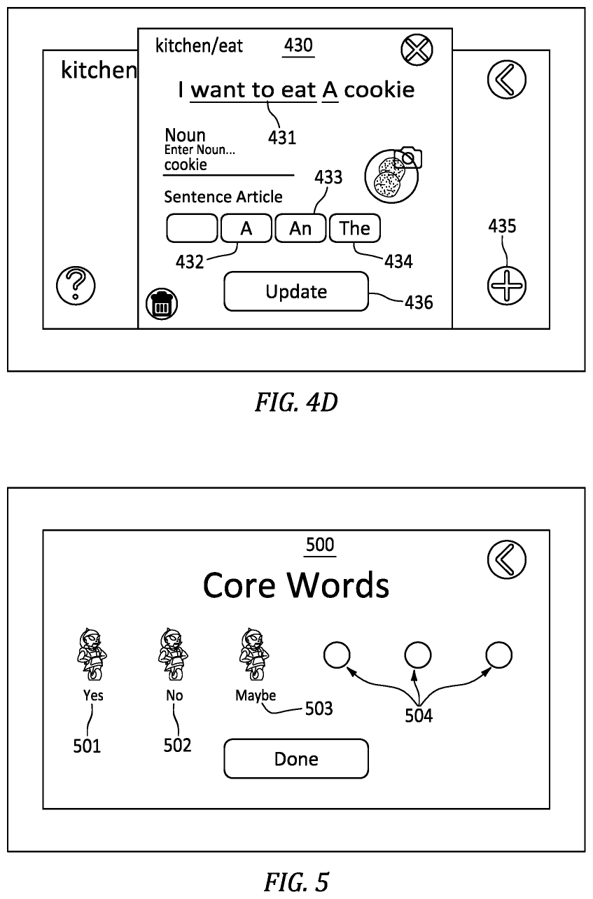

FIG. 4A illustrates one nonlimiting embodiment of an exemplary Locations presentation screen 400 that can be generated by the interface device 110 in response to the caregiver selecting the Data Bank tab 305 at step 210. As shown, the Locations screen can include a list of locations where the primary user may request certain items or activities. In the illustrated embodiment, the Location screen 400 has been updated to include a Kitchen tab 401, a Home tab 402 and a Bedroom tab 403, each having an accurate image of the associated location. Of course, any number of additional or different locations can be added 404 by the caregiver as appropriate.

Upon selecting or uploading a location at step 215, the method can proceed to step 220 where the user can upload any number of verbs describing an action that would take place in the specified location (e.g., location-specific verbs). To this end, FIG. 4B illustrates one nonlimiting embodiment of an exemplary Location-specific Verb presentation screen 410 that can be generated by the interface device 110 in response to the caregiver selecting the Kitchen tab 401 at step 215. As shown, the Verb screen 410 can include any number of verbs pertaining to actions that would normally be taken in a kitchen. Several nonlimiting examples include the illustrated Eat tab 411, and Drink tab 412. Likewise, any number of additional or different verbs can be added 413 by the caregiver as appropriate.

Upon selecting or uploading a location-specific verb at step 220, the method can proceed to step 225 where the user can upload any number of location-specific nouns. To this end, FIG. 4C illustrates one nonlimiting embodiment of an exemplary Location-specific Noun presentation screen 420 that can be generated by the interface device 110 in response to the caregiver selecting the Eat tab 411 at step 220. As shown, the illustrative Noun screen 420 can include any number of Nouns representing items that would be found to eat in a kitchen. Several nonlimiting examples include the illustrated Pineapple 421, Cookie 422, and Chips 423, among others, for example. Likewise, any number of additional or different food related verbs can be added 424 by the caregiver as appropriate.

Upon selecting or uploading a location-specific noun at step 225, the method can proceed to step 230 where the user can upload any number of sentence articles to promote proper sentence structure. To this end, FIG. 4D illustrates one nonlimiting embodiment of an exemplary Sentence Article presentation screen 430 that can be generated by the interface device 110 in response to the caregiver selecting the Cookie tab 422 at step 225.

As shown, the Sentence Article screen 430 can be uploaded to include articles used in proper sentence structures containing the selected verb and noun. Several nonlimiting examples can include the illustrated “I want to eat” 431, “A” 432, “An” 433 and “The” 434, among others, for example. Likewise, any number of additional or different sentence articles can be added 435 and updated 436 by the caregiver as appropriate. Upon selecting or updating the sentence articles, the caregiver can be returned to the user customization presentation screen 300.

FIG. 5 illustrates one nonlimiting embodiment of an exemplary Core Words presentation screen 500, which can be generated and displayed on the primary interface device 110 in response to the caregiver selecting the “Core Words” tab 310 from the Customization screen 300 at step 235. As described herein, Core Words includes a library of common words used in everyday communication. Several nonlimiting examples include the illustrated “Yes” 501, “No” 502, and “Maybe” 503. Of course, any number of additional or different words can be added 504 by the caregiver as appropriate.

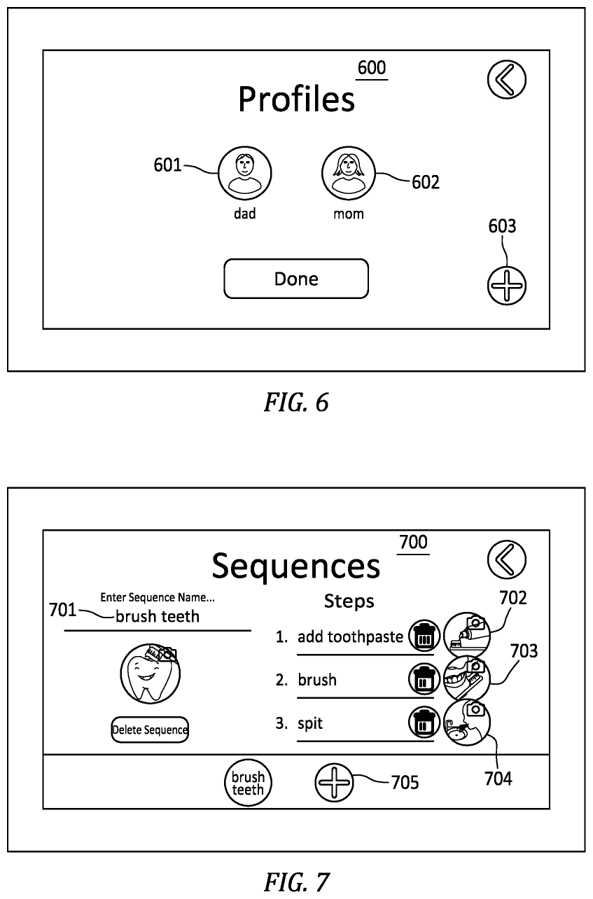

FIG. 6 illustrates one nonlimiting embodiment of an exemplary Profiles presentation screen 600, which can be generated and displayed on the primary interface device 110 in response to the caregiver selecting the “Profiles” tab 315 from the Customization screen 300 at step 240. As described herein, the Profiles screen represents a library of individual caregivers and other individuals with whom the primary user communicates with. As will be described below, each of the caregivers may be assigned an individual caregiver interface device 120, and can be notified through that device when the primary user is communicating with them and/or can push schedule and sequence notifications to the primary device. In the illustrated embodiment, the listed caregivers include “Dad” 601, and “Mom” 602; however, any number of additional or different individuals can be added 603.

FIG. 7 illustrates one nonlimiting embodiment of an exemplary Sequences presentation screen 700, which can be generated and displayed on the primary interface device 110 in response to the caregiver selecting the “Sequences” tab 320 from the Customization screen 300 at step 245. As described herein, the Sequences screen represents a library of sequences each having a set number of steps that can be taken by the primary user to achieve a goal or perform an activity.

In the illustrated exemplary embodiment, the caregiver has uploaded a sequence called “Brush Teeth” 701, having the individual steps and pictures showing “add toothpaste” 702, “brush” 703, and “spit and rinse” 704. Of course, any number of additional steps and/or different sequences can be added 705. Several nonlimiting examples of different sequences may include activities such as “clean your room,” “feed the dog,” or “tie your shoes,” for example.

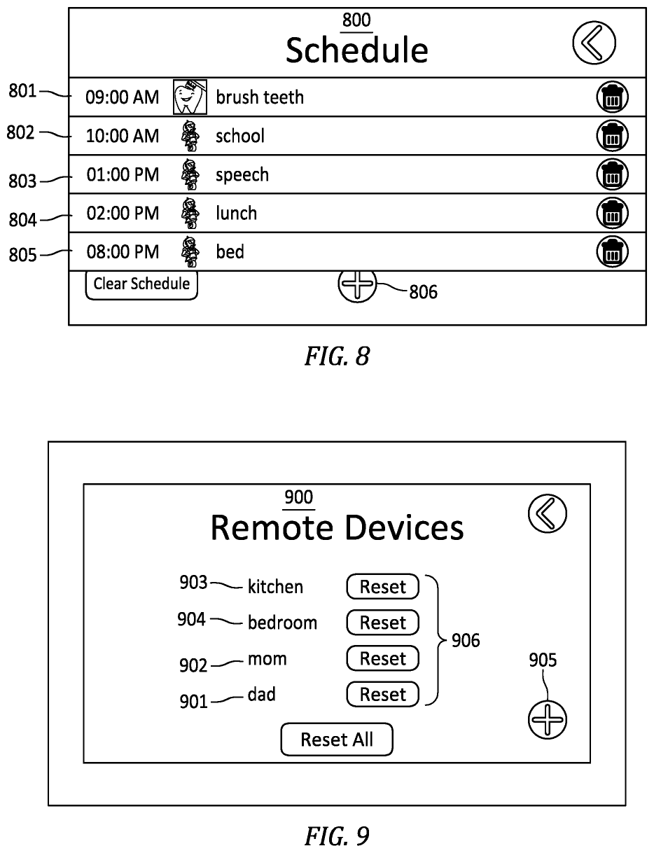

FIG. 8 illustrates one nonlimiting embodiment of an exemplary Schedule presentation screen 800, which can be generated and displayed on the primary interface device 110 in response to the caregiver selecting the “Schedule” tab 325 from the Customization screen 300 at step 250. As described herein, the Schedule screen represents a library containing the daily, weekly, or monthly schedule of events pertaining to the primary user. Although described herein as accessing and updating this section using the primary interface device 110 at the initial setup, this is for illustrative purposes only. To this end, the schedule can be accessed, updated and/or changed at any time by a caregiver using the caregiver interface device 120 in the same manner described here. Once updated on the caregiver device, the changes will be sent to the primary interface device 110 for storage and access by the primary user.

In the illustrated exemplary embodiment, the primary user's daily schedule for today is shown. At this point, it is noted that the schedule can contain sequences, as described above with regard to step 245, along with other events or activities. Thus, in the illustrated embodiment, the schedule includes the sequence “Brush Teeth” 801, “school” 802, “Speech” 803, “Lunch” 804, and “bed” 805. Of course, any number of additional sequences can also be added 806 containing additional appointments or activities for the hour, day, week or month, for example.

FIG. 9 illustrates one nonlimiting embodiment of an exemplary Remote Devices presentation screen 900, which can be generated and displayed on the primary interface device 110 in response to the caregiver selecting the “Remote Devices” tab 330 from the Customization screen 300 at step 255. As described herein, Remote Devices includes a library of each caregiver interface device 120, and location-specific interface devices 130 that are linked with the primary interface device 110.

In the illustrated embodiment, the system includes two caregiver interface devices 120 named “Dad” 901, and “Mom” 902, along with two location-specific interface devices 130 named “Kitchen” 903 and “bedroom” 904. Of course, any number of additional or different interface devices 120 and 130 can be added 905 by the caregiver as appropriate, and/or reset 906.

Finally, the configuration method can proceed to step 260 where each of the location-specific interface devices 130 configured in step 255 can be installed. As described herein, the location-specific interface devices will preferably be installed at the same locations identified above at step 215, where the primary user routinely visits and/or performs certain activities, such as the Kitchen or bedroom described above. In either instance, each device can be mounted to any suitable structure in the designated location utilizing any suitable hardware and can be powered by plugging the device into a standard electrical outlet.

Once the location-specific interface device(s) 130 are linked to the primary interface device 110, the primary device will automatically associate the location-specific functionality (updated at steps 215-225) of that location to that corresponding location-specific device. In this regard, when the primary user makes a request on their device 110 that involves a particular location (e.g., drink water), the designated interface device 130 at the location (e.g., the kitchen) will activate and display the request. As should be apparent, location specific requests are not limited by or tied to a user/caregiver from whom the primary user may ask for help.

Finally, once the caregiver devices 120 are linked to the primary interface device 110, the primary device will automatically associate requests for a particular caregiver (updated at step 240) to that caregiver's device. In this regard, when the primary user makes a request for Mom, the device 120 assigned to Mom will activate and display the request. As should be apparent, caregiver specific requests are not limited by or tied to a particular location.

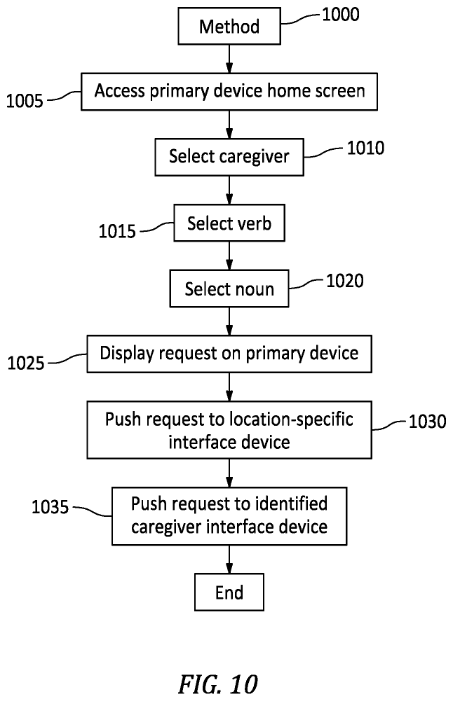

FIG. 10 illustrates an exemplary flow chart method 1000 for performing interactive communication using the system 100. As will be described, the system is designed to utilize the user-specific information uploaded in the customization method to allow the primary user to convey any number of different wants and needs using the primary interface 110. As each communication string is conducted, the primary device will reinforce speech habits by audibly speaking the request to the primary user, and stimulating them with custom animations.

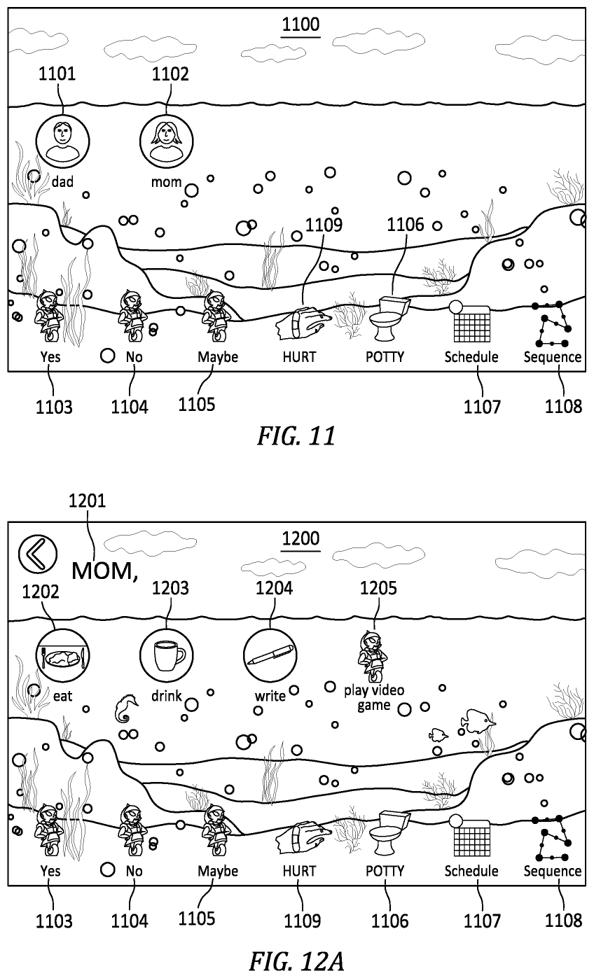

FIG. 11 illustrates one nonlimiting embodiment of an exemplary user home presentation screen 1100, which can be generated by and displayed on the primary interface device 110. In the illustrated embodiment, the page 1100 can include the name and picture of each caregiver and/or family member such as “Dad” 1101, and “Mom” 1102, for example, that were updated at step 240 above. Additionally, the page can include the list of core words such as “Yes” 1103, “No” 1104, “Maybe” 1105, and “Potty” 1106, along with the “Schedule” 1107 and “Sequences” 1108 that were updated by the caregiver at steps 235, 245 and 250 above. Finally, the home page can include a “Hurt” tab 1109.

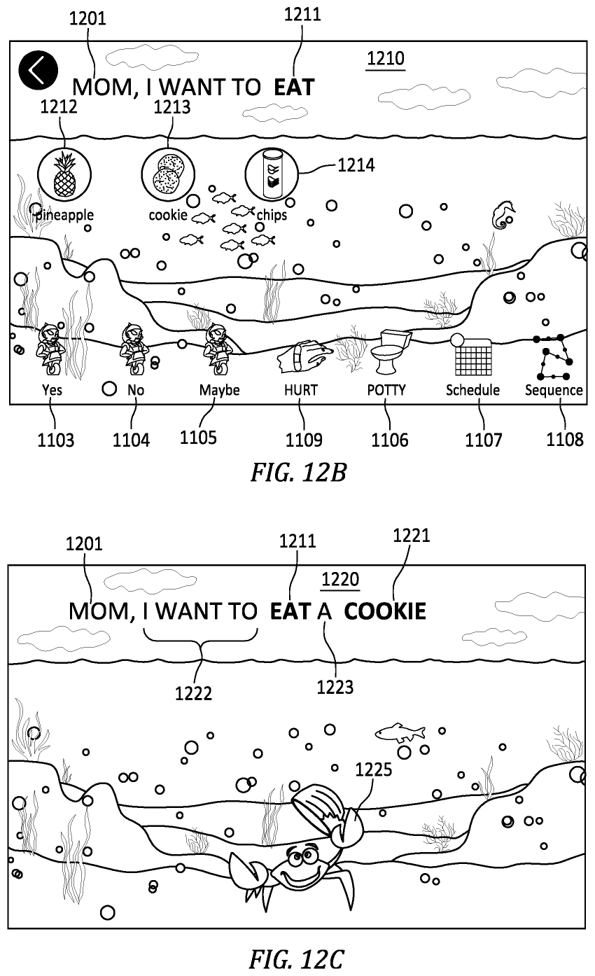

FIG. 12A illustrates one nonlimiting embodiment of an exemplary caregiver specific verb request screen 1200, which can be generated and displayed on the primary interface device 110 in response to the primary user selecting one the caregivers tab “Mom” 1102 from the home screen 1100 at step 1010. As shown, the bottom of the screen can continue to display the core words as noted above, and can also display the request in sentence form at the top of the page beginning with the selected caregiver Mom 1201. Next, a series of verbs that were uploaded at step 220 can be displayed in the middle of the screen. In the present embodiment, the verbs include “Eat” 1202, “Drink” 1203, “Write” 1204 and “Play Video Game” 1205.

FIG. 12B illustrates one nonlimiting embodiment of an exemplary caregiver specific noun request screen 1210, which can be generated and displayed on the primary interface device 110 in response to the primary user selecting the caregiver “Mom” 1102 from the home screen 1100 at step 1010, and the verb tab “Eat” 1202 from the Verb screen 1200 at step 1015. As shown, the top of the screen continues to display the request in sentence form beginning with the selected caregiver (Mom) 1201, and verb (Eat) 1211. Next, a series of nouns that were uploaded at step 225 can be displayed in the middle of the screen. In the present embodiment, the Verb specific nouns include “Pineapple” 1212, “Cookie” 1213, and “Chips” 1214.

Upon the user selecting a noun at step 1020, the method can proceed to step 1025 where an announcement screen can be generated. FIG. 12C illustrates one nonlimiting embodiment of an exemplary announcement screen 1220, which can be generated and displayed on the primary interface device 110 in response to the primary user selecting the caregiver “Mom” 1102, the verb “Eat” 1202, and the noun “Cookie” 1213 as noted above.

As shown, the top of the screen displays the full request in sentence form beginning with the selected caregiver (Mom) 1201, verb (Eat) 1211 and noun (Cookie) 1221, along with the proper sentence structure articles “I want” 1222 and “a” 1223 that were added in the configuration step at 230. In addition to displaying the request in proper sentence form, an animation 1225 can travel across the screen, and the speaker will speak the request “Mom, I want to eat a cookie”.

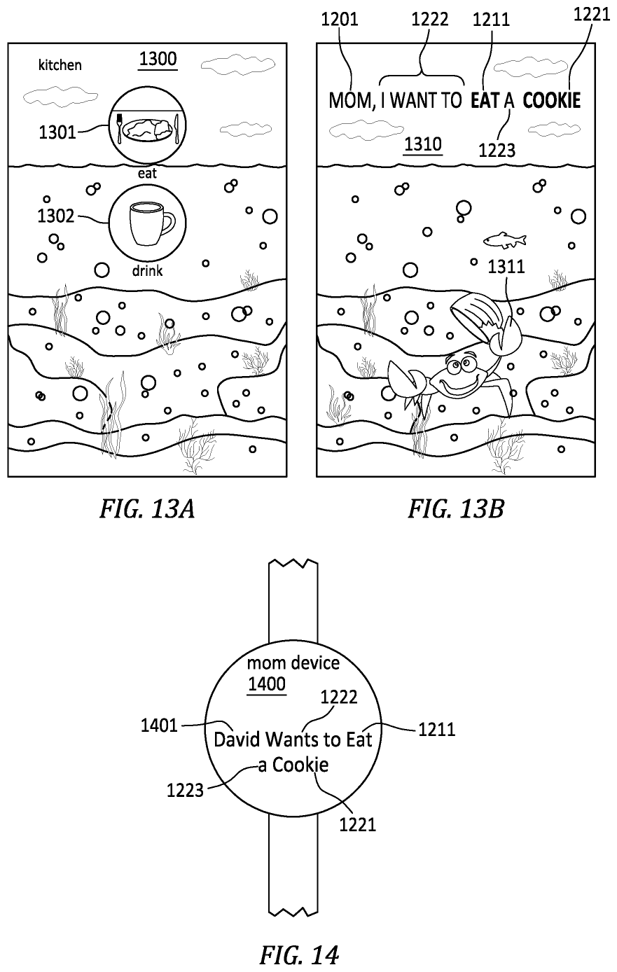

Next, the method can proceed to step 1030 where the primary interface device can push a notification to the location-specific interface device 130 for the location where the request is made. To this end, FIG. 13A illustrates one nonlimiting embodiment of an exemplary location-specific device home screen 1300 that can be displayed on the kitchen device 130 configured above at step 255. As shown, the kitchen device 130 can initially display the listing of kitchen-related verbs that were updated at step 220. In the illustrated embodiment, these include the “Eat” tab 1301 and “Drink” tab 1302., however any number of other options can be provided.

As noted above, the kitchen device can be physically mounted to a structure in the Kitchen so as to always be available to display kitchen related actions (e.g., verbs and nouns). The device 130 can be used directly by the primary user wherein he or she can select one of the tabs 1301 or 1302 to convey a kitchen-specific request. Upon selecting the Verb tab, the appropriate noun tabs will be listed (See FIG. 12B).

FIG. 13B illustrates one nonlimiting embodiment of an exemplary announcement screen 1310 that can be displayed on the location-specific device upon the primary user making a direct request using the interface of the device. The same screen can also be displayed automatically upon receipt of the push notification from the primary device at step 1030. In the illustrated example, the screen 1310 can display the full request in sentence form beginning with the selected caregiver (Mom) 1201, verb (Eat) 1211 and noun (Cookie) 1221, along with the proper sentence structure articles “I want” 1222 and “a” 1223 that were added in the configuration step at 230. In addition to displaying the request in proper sentence form, an animation 1311 can travel across the screen, and the speaker of the location-specific device will speak the request “Mom, I want to eat a cookie”.

Finally, the method can proceed to step 1035 where the primary interface device can push a notification to the caregiver interface device 120 for the caregiver selected at step 1020. To this end, FIG. 14A illustrates one nonlimiting embodiment of an exemplary announcement screen 1400 that can be displayed on the caregiver interface device 120 assigned to Mom at step 255. As shown, the caregiver device (illustrated exemplary as a smartwatch) can display the full request in sentence form beginning with the name of the primary user “David” 1401, along with the verb (Eat) 1211 and noun (Cookie) 1221, and proper sentence structure articles “I want” 1222 and “a” 1223 that were added in the configuration step at 230.

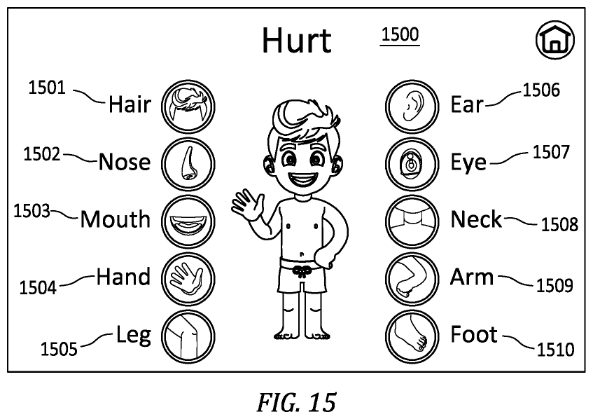

In addition to the above, the primary user can convey other information such as when they are not feeling well. To this end, FIG. 15 illustrates one nonlimiting embodiment of a Hurt screen 1500 that can be generated and displayed on the primary interface device 110 in response to the primary user selecting the “Hurt” tab 1109 from the home screen 1100. As shown, the Hurt screen can show an illustration of a child (boy or girl) and a series of body parts such as the hair 1501, nose 1502, mouth 1503, hand 1504, leg 1505, ear 1506, eye 1507, mouth 1508, arm 1509 and foot 1510, for example. Upon selecting an appropriate body part, the primary interface device will generate a statement containing the selected part e.g., “My ear hurts” and will display the same in written word and spoken word in a manner identical to that described above with respect to a request for a cookie. Additionally, each caregiver device will be pushed the notification stating the primary users name and the part of the body that hurts—e.g., “David's ear hurts”.

Although described above with regard to statements from the primary user to others, the system includes functionality for two way communication. In this regard, each of the sequences uploaded at step 245 can be pushed to the primary interface device from the caregiver device at any time. Upon receipt of the sequence, the primary user can perform the activities one step at a time through voice, word and picture prompts on the screen. (E.g., add toothpaste, brush and spit). Upon completion of each step, the primary device can send a notification to the caregiver device that requested the sequence to be performed so that caregiver can monitor the primary user's status.

As noted above, sequences can be built into the schedule portion of the primary interface device and can be displayed on the device in a similar manner as that shown above at FIG. 8.

Accordingly, the above described interactive communication system provides a plurality of connected devices that permit clear communication between a special-needs individual and a caregiver, while reinforcing spoken words and sight/word recognition.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, aspects of the present invention may be embodied as a system, method, or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An interactive communication system, comprising:
a primary interface device having an onboard processor, a memory, and a touch screen display;
a data bank library that is positioned within the memory of the primary interface device, said data bank library including a plurality of location specific components;
an announcement engine that is located within the primary interface device, said engine including functionality for generating an announcement that includes a desired action containing at least one of the plurality of location specific components;
at least one caregiver interface device having an onboard processor, a memory, and a display; and
at least one location-specific interface device having an onboard processor, a memory, and a touch screen display,
wherein each of the primary interface device, the at least one caregiver interface device and the at least one location-specific interface device are in wireless communication, and
wherein the primary interface device includes functionality for selectively pushing a generated announcement to at least one of the caregiver interface devices or the location-specific interface devices.

2. The system of claim 1, wherein the location specific components includes a plurality of different physical locations.

3. The system of claim 2, wherein the location specific components further includes at least one verb for each of the plurality of different physical locations.

4. The system of claim 3, wherein the location specific components further includes at least one noun for each of the at least one verb.

5. The system of claim 2, wherein at least one of the plurality of different locations is assigned to the at least one location-specific interface device.

6. The system of claim 5, wherein the announcement engine includes functionality for pushing the generated announcement only to the location-specific interface device having the plurality of location specific components.

7. The system of claim 6, wherein simultaneously to pushing the announcement, the primary interface device audibly states the generated announcement.

8. The system of claim 1, further comprising:
a caregiver library that is positioned within the memory of the primary interface device, said caregiver library including at least one caregiver name for a user of the primary interface device.

9. The system of claim 8, wherein each of the at least one caregiver interface device is linked to a caregiver name within the caregiver library.

10. The system of claim 9, wherein the announcement engine includes functionality for inserting a selected caregiver name into the generated announcement.

11. The system of claim 10, wherein the announcement engine includes functionality for pushing the generated announcement only to the caregiver interface device of the caregiver name inserted into the generated announcement.

12. The system of claim 11, wherein simultaneously to pushing the announcement, the primary interface device audibly states the generated announcement.

13. The system of claim 1, further comprising:
a core word library that is positioned within the memory of the primary interface device, said core word library including at least one of the words yes, no, or maybe.

14. The system of claim 13, wherein each word of the core word library is displayed on a home screen of the primary interface device.

15. The system of claim 14, wherein the primary interface device is configured to detect a user selecting one of the core words from the core word library displayed on the home screen and to audibly state the selected core word.

16. A method of performing interactive communication, said method comprising:
providing a primary interface device, a caregiver interface device, and a location-specific interface device;
inputting a plurality of location specific components into the primary interface device, said location specific components including a location, a verb associated with the location, and a noun associated with the verb;
assigning the location-specific interface device to the location;
assigning a caregiver name to the caregiver interface device;
receiving a request from a primary interface device user that includes each of the caregiver name, the verb and the noun;
announcing the request via a speaker on the primary interface device; and
pushing the request to each of the caregiver interface device and the location-specific interface device.
